(19) United States
(12) Patent Application Publication
(10) Pub. No.: US 2008/0202597 A1
(43) Pub. Date: Aug. 28, 2008

(54) Explosion-proof diaphragm valve assembly

(75) Inventor: hsi-Chun Chung, Lu Chou City (TW)

Correspondence Address: TROXELL LAW OFFICE PLLC, SUITE 1404, 5205 LEESBURG PIKE, FALLS CHURCH, VA, 22041, US

(73) Assignee: Bag Filter Enterprise Co., Ltd.

(21) Appl. No.: 11/711,136

(22) Filed: Feb. 27, 2007

(51) Int. Cl. F16K 51/00

(52) U.S. Cl. 137/315.03

(57) ABSTRACT

An explosion-proof diaphragm valve assembly includes a valve body, which comprises a lower casing, a diaphragm mounted in the lower casing, an upper casing that is affixed to the top side of the lower casing with screws and defines an upwardly protruding hollow chamber, and a top cover affixed to the upper casing with screws to close the hollow chamber, and a magnetic valve mounted in the valve body and protected by the top cover and controlled to move the diaphragm.

### BACKGROUND OF THE INVENTION

1. Field of the Invention

The present invention relates generally to valves and more particularly, to an explosion-proof diaphragm valve assembly.

2. Description of the Related Art

In industrial production and solid waste incineration, waste gas cleaning is quite important. Normally, waste gas must be treated through a dust collection process before discharge. A dust collection equipment for this purpose generally comprises a plurality of racks, and a plurality of filter bags respectively fastened to the racks for removing dust from waste gas. To prevent accumulation of dust in the surface of each filter bag, a diaphragm valve is installed in each rack and controlled to add pressure to waste gas toward the inside of the associating filter bag, forcing accumulated dust away from the surface of the associating filter bag, and fallen dust is then collated through a hopper below.

To save energy and obtain optimal cleaning effect, the applied air pressure must be high, and each diaphragm valve must be opened and then closed transiently within few laps. The control of a small-sized diaphragm valve does not cause any problems. However, when a big output pipe is connected to the diaphragm valve, a differential pressure linking control is necessary, i.e., the diaphragm valve has two air chambers of different sizes and two different diaphragms respectively mounted in the air chambers. The diaphragms are flexible, each having a hard center portion for closing the respective connecting pipe, and a plurality of air holes around the border area. Gas from the connection pipe is guided through the air holes of the diaphragms into the associating air chambers. Magnetic valve means is controlled to move the diaphragms. When the magnetic valve means is turned off, the diaphragms close the air chambers. On the contrary, when the magnetic valve means is turned on, the diaphragms open the air chambers.

A diaphragm valve of the aforesaid design is functional. However, it is not safe when used in a dust-intensive area. When dust concentration surpasses a predetermined value (critical condition for explosion), electrostatic discharge sparks or an external flame may cause explosion. More particularly, in a nanometered engineering to produce a nanometered powder material, a big amount of dust will be produced. The fine particle size of the dust requires a small amount of energy to cause explosion. In this case, small friction sparks or static electricity can cause the dust to explode.

To prohibit the production of sparks during an industrial application, as shown in FIG. 1, the magnetic valves that control the operation of diaphragms of different diaphragm valves are gathered in an enclosed box far away from the dust-intensive area. This method effectively isolates electrical parts from dust environment, keeping sparks from the start of the magnetic valves away from dust environment. This arrangement prevents industrial dust explosion.

However, the aforesaid arrangement requires the installation of the enclosed box and the related piping and wiring, thereby increasing dust collection equipment installation cost. Further, because the magnetic valves and the diaphragm valves are set apart at a distance, connecting members are necessary to connect the diaphragm valves to the associating magnetic valves. This arrangement may cause a delay during operation, i.e., the diaphragms cannot be quickly operated

There are integral designs in which the magnetic valve is protected within an explosion-proof shell of the diaphragm valve. However, these integral designs are expensive. Further, the maintenance work of these integral designs is complicated. These drawbacks will cut the profit. Few people can accept these integral designs.

Therefore, it is desirable to provide a diaphragm valve that eliminates the aforesaid problems.

### SUMMARY OF THE INVENTION

The present invention has been accomplished under the circumstances in view. It is the main object of the present invention to provide an explosion-proof diaphragm valve assembly, which has a simple structure and is inexpensive to manufacture. It is another object of the present invention to provide an explosion-proof diaphragm valve assembly, which can quickly be started without delay. It is still another object of the present invention to provide an explosion-proof diaphragm valve assembly, which prevents sparks and achieve the effect of anti-explosion.

To achieve this and other objects of the present invention, the explosion-proof diaphragm valve assembly comprises a valve body, and a magnetic valve. The valve body comprises a lower casing, a diaphragm mounted in the lower casing, and an upper casing affixed to the top side of the lower casing with screws. The magnetic valve is mounted in the valve body and controlled to move the diaphragm. The upper casing has an upwardly protruding hollow chamber that accommodates the magnetic valve, and a top cover affixed to the upper casing with screws to close the hollow chamber. The hollow chamber has a side hole for the passing of the power cord of the magnetic valve.

### BRIEF DESCRIPTION OF THE DRAWINGS

FIG. 1 is an applied view of a conventional diaphragm valve.

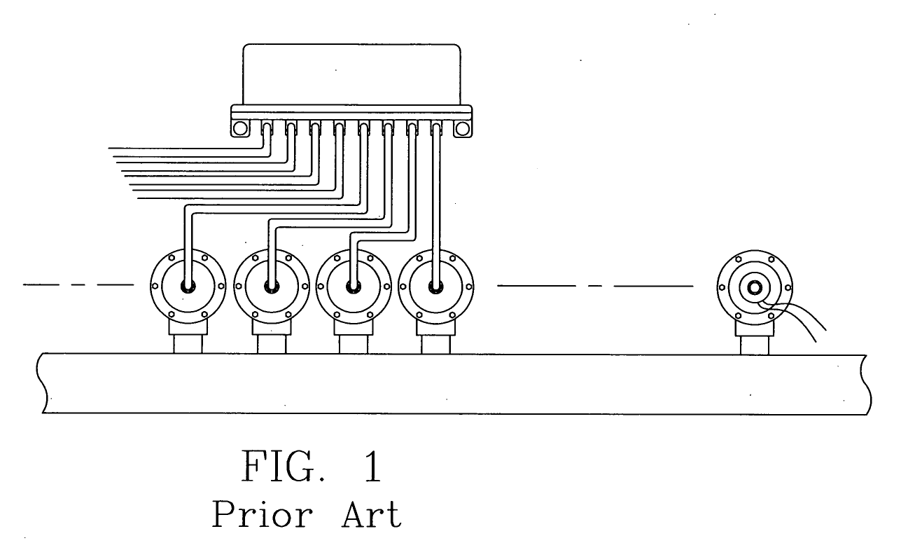

FIG. 2 is an exploded view of an explosion-proof diaphragm valve assembly according to the present invention.

FIG. 3 is an elevational assembly view of the explosion-proof diaphragm valve assembly according to the present invention.

FIG. 4 is a plain view of the explosion-proof diaphragm valve assembly according to the present invention.

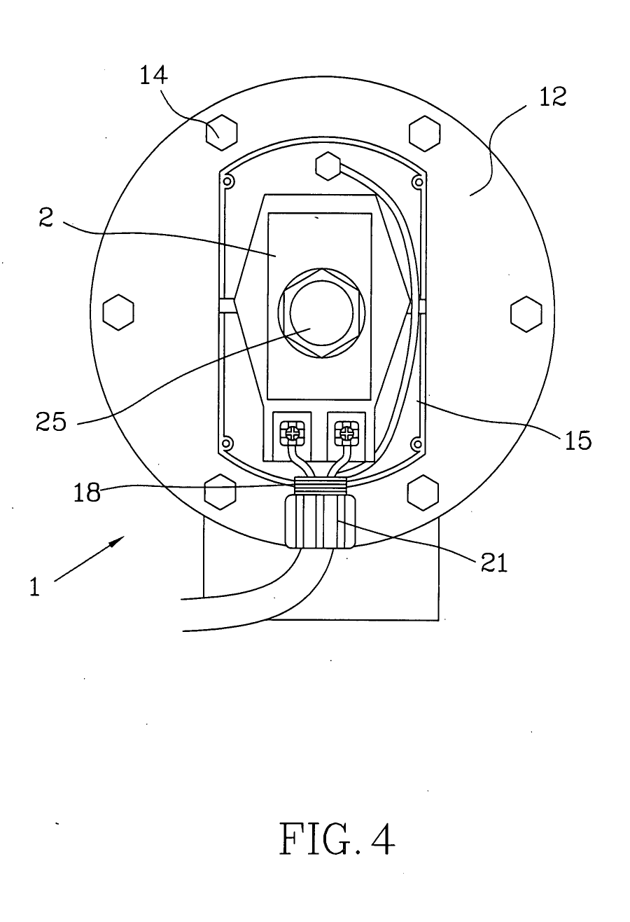

FIG. 5 is an elevational view of an alternate form of the explosion-proof diaphragm valve assembly according to the present invention.

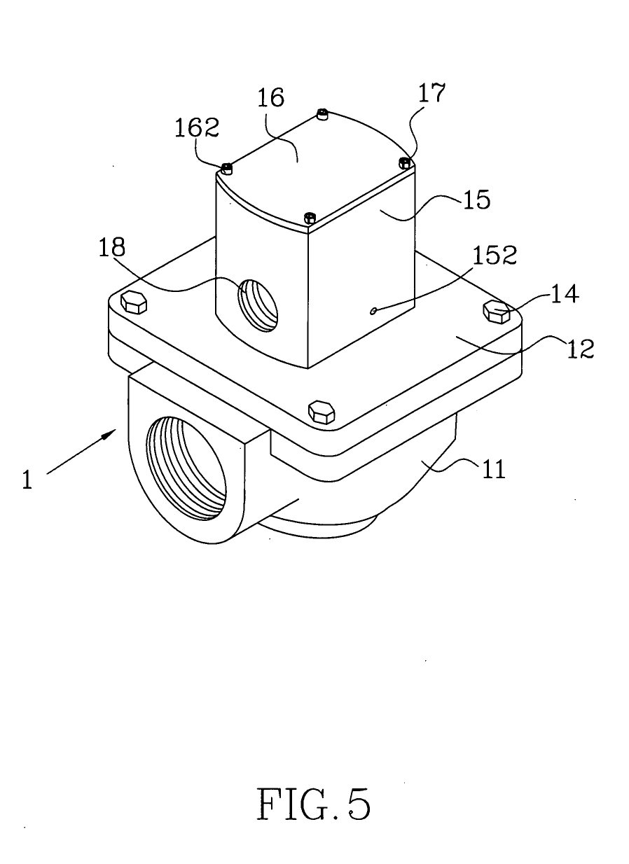

FIG. 6 is a plain view of the explosion-proof diaphragm valve assembly shown in FIG. 5.

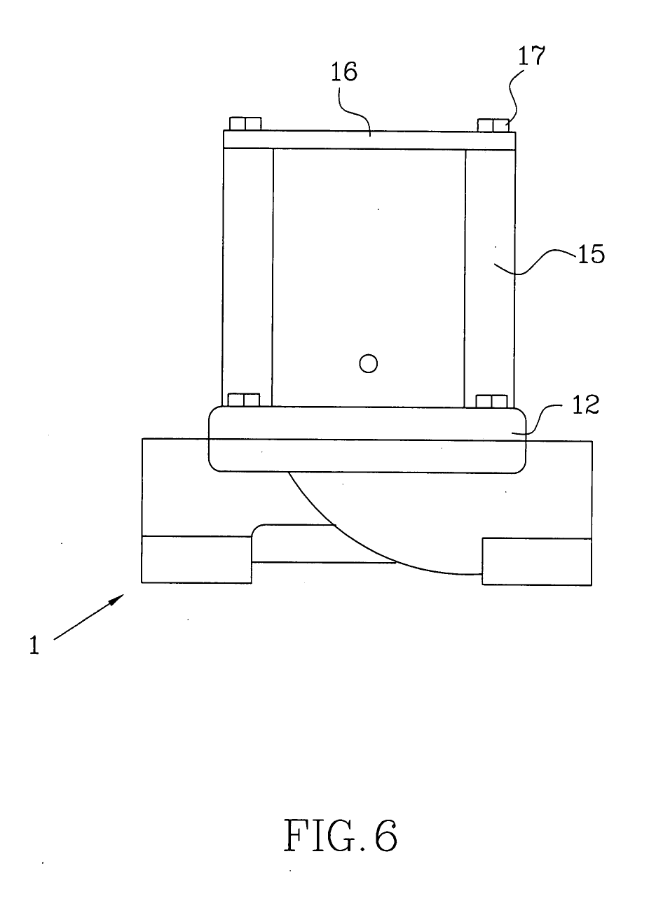

FIG. 7 is an elevational view of another alternate form of the explosion-proof diaphragm valve assembly according to the present invention.

### DETAILED DESCRIPTION OF THE INVENTION

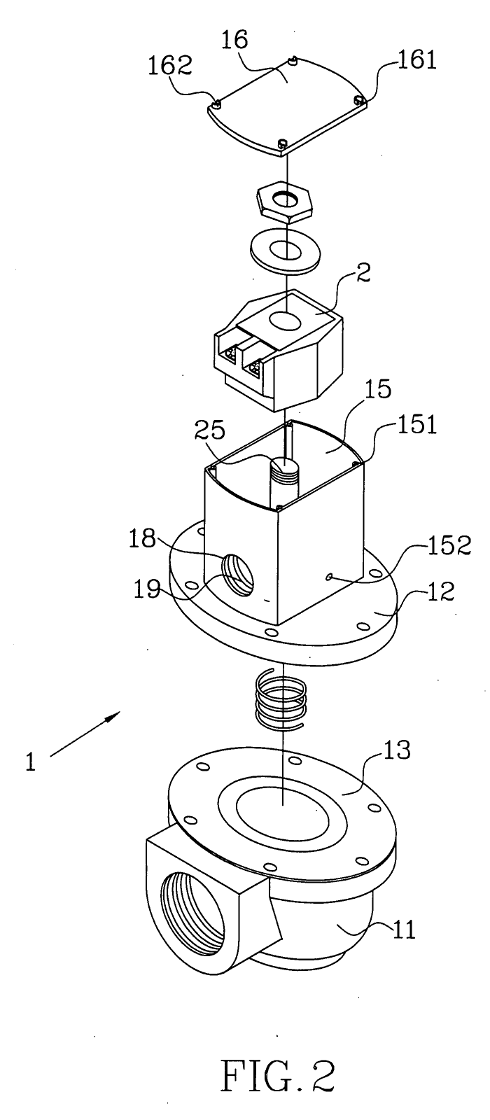

Referring to FIGS. 2˜7 an explosion-proof diaphragm valve assembly in accordance with the present invention is shown comprised of a valve body 1 and a magnetic valve 2. The valve body 1 is comprised of a lower casing 11, a diaphragm 13 mounted in the lower casing 11, and an upper casing 12 affixed to the top side of the lower casing 11 with screws 14. The magnetic valve 2 is mounted in the upper casing 12 and controlled to move the diaphragm 13. The main features of the present invention are described hereinafter.

In the center of the upper casing 12 has an upwardly protruding hollow chamber 15 that accommodates the magnetic valve 2, and a top cover 16 affixed to the top side of the hollow chamber 15 with screws 17 to close the hollow chamber 15. The hollow chamber 15 has a side hole 18 for the passing of the power cord of the magnetic valve 2. In application, the magnetic valve 2 is well protected inside the hollow chamber 15 of the valve body 1 and kept from sight for quick operation without delay, preventing sparks and achieving the effect of anti-explosion.

In actual practice, the hollow chamber 15 can be formed integral with the top side of the upper casing 12, having the shape of a barrel. The reciprocating rod 25 of the magnetic valve 2 is axially disposed at the center of the hollow chamber 15. Further, the hollow chamber 15 has two air holes 152 cut through both sides of the peripheral wall thereof, and a plurality of stud holes 151 respectively and axially disposed in the four corners. The top cover 16 fits the cross section of the hollow chamber 15, having a plurality of mounting through holes 161 respectively disposed in the four corners and a plurality of protective flanges 162 respectively protruded from the top wall of the top cover 16 around each of the through holes 161. The screws 17 are respectively mounted in the mounting through holes 161 and fastened to the stud holes 151 to affix the top cover 16 to the hollow chamber 15 of the valve body 1. Further, an inner thread 19 is provided in the side hole 18 for the mounting of a screw cap 21.

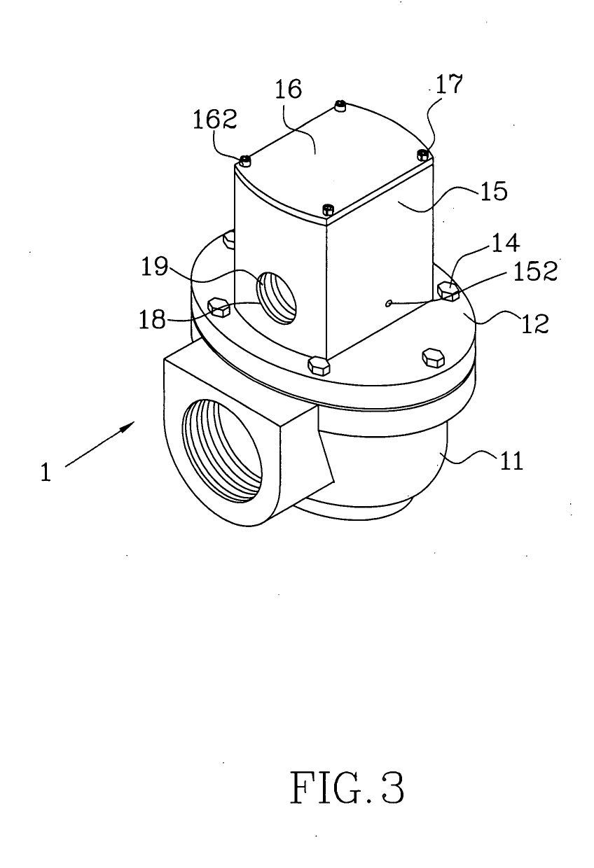

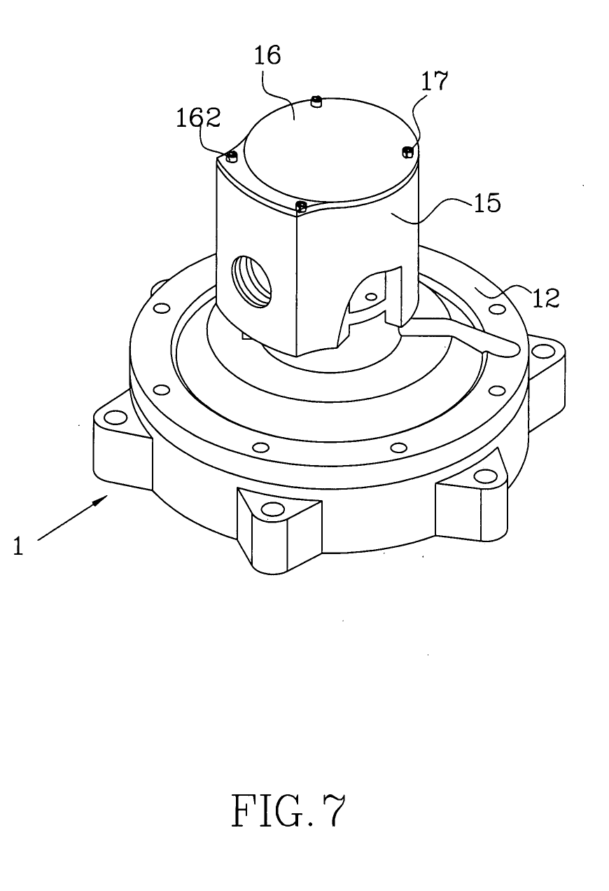

Referring to FIGS. 3˜6 again, the valve body 1 can be made having a disk-like or quadrilateral profile in any of a variety of sizes. Further, the valve body 1 can be made having multiple layers of diaphragm 13, as shown in FIG. 7. In this case, the bottom wall of the hollow chamber 15 is lifted while the other parts of valve body 1 remains unchanged.

Referring to FIGS. 2˜4 again, by means of selectively change the upper casing 12, the explosion-proof diaphragm valve assembly can easily be installed in a dust-intensive area or dangerous area, eliminating the complicated prior art procedure of gathering magnetic valves in a box and arranging an extra piping system. Furthermore, because the explosion-proof diaphragm valve assembly has a simple integral structure, its manufacturing cost is low and acceptable to most users. During application, the magnetic valve 2 of the explosion-proof diaphragm valve assembly is well protected in the hollow chamber 15, preventing sparks and achieving the effect of anti-explosion. Further, the magnetic valve 2 can quickly be started, eliminating the delay action problem of the prior art design.

A prototype of explosion-proof diaphragm valve assembly has been constructed with the features of FIGS. 2˜7. The explosion-proof diaphragm valve assembly functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An explosion-proof diaphragm valve assembly comprising
a valve body, said valve body comprising a lower casing, a diaphragm mounted in said lower casing, and an upper casing affixed to a top side of said lower casing with screws; and
a magnetic valve mounted in said valve body and controlled to move said diaphragm;
wherein said upper casing has an upwardly protruding hollow chamber that accommodates said magnetic valve, and a top cover affixed to said upper casing with screws to close said hollow chamber, said hollow chamber having a side hole for the passing of a power cord of said magnetic valve.

2. The explosion-proof diaphragm valve assembly as claimed in claim 1, wherein said hollow chamber is formed integral with said upper casing, having the shape of a barrel, two air holes cut through both sides thereof, and a plurality of stud holes respectively and axially disposed in four corners thereof; said magnetic valve has a reciprocating rod axially disposed at the center of said hollow chamber; said top cover fits the cross section of said hollow chamber, having a plurality of mounting through holes respectively fastened to the stud holes of said hollow chamber with screws, and a plurality of protective flanges respectively protruded from a top wall thereof around each of said through holes.

3. The explosion-proof diaphragm valve assembly as claimed in claim 1, wherein the side hole of said hollow chamber has an inner thread for the mounting of a screw cap.

4. The explosion-proof diaphragm valve assembly as claimed in claim 1, wherein said valve body has a disk-like profile.

5. The explosion-proof diaphragm valve assembly as claimed in claim 1, wherein said valve body has a quadrilateral profile.

6. The explosion-proof diaphragm valve assembly as claimed in claim 1, wherein said diaphragm has multiple layers.
